(19) United States
(12) Patent Application Publication
(10) Pub. No.: US 2026/0247250 A1
(43) Pub. Date: Aug. 20, 2026

(54) METHOD AND APPARATUS FOR OPTIMIZING LOWER TRIGGERED MOBILITY (LTM) IN A COMMUNICATION SYSTEM

(71) Applicant: Samsung Electronics Co., Ltd., Suwon-si, Gyeonggi-do (KR)

(72) Inventor: Aby Kanneath ABRAHAM, Bangalore (IN)

(21) Appl. No.: 19/164,438

(22) PCT Filed: May 3, 2024
(86) PCT No.: PCT/KR2024/005998

§ 371 Date: Sep. 11, 2025

(30) Foreign Application Priority Data
May 3, 2023 (IN) 202341031633
Apr. 16, 2024 (IN) 202341031633

(51) Int. Cl. H04W 36/32; H04W 36/00

(52) U.S. Cl. CPC H04W 36/324; H04W 36/0079

(57) ABSTRACT

The disclosure relates to a 5G or 6G communication system for supporting a higher data transmission rate. A method performed by a terminal in the system, comprises receiving, from a base station, a message comprising configuration information on a successful handover, and in case that the terminal performs a layer 1/layer 2 (L1/L2) triggered mobility (LTM) cell switch, releasing the configuration information on the successful handover, wherein the LTM cell switch is triggered by the base station.

### TECHNICAL FIELD

The proposed embodiments relate to telecommunication network system. More particularly present disclosure relates to optimizing Lower Triggered Mobility (LTM) in a telecommunication network system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.A 5G NR (new radio) radio access network also known as Next Generation Radio Access Network (NG-RAN) comprises a number of NR base stations knows as gNodeB (gNBs). The gNBs can be connected with each other through Xn interface, and will be connected to various core network elements like Access and Mobility Management Function (AMF), User Plane Function (UPF) and the like. Further, the gNBs can be divided into two physical entities named Centralized Unit (CU) and Distributed Unit (DU). The CU provides support for the higher layers of the protocol stack such as Session Data Application Protocol (SDAP), Packet Data Convergence Protocol (PDCP) and Radio Resource Control (RRC) while the DU provides support for the lower layers of the protocol stack such as Radio Link Control (RLC), Medium Access Control (MAC) and Physical layer. Each gNB can have multiple cells serving many User Equipment (UEs). Especially, identifying most optimal radio parameters and operators used to resort to manual techniques like drive tests to identify the optimal parameters is difficult. However, such manual parameter tuning is a costly operation since the manual tuning depends on a lot of factors like the number of users, a number of neighbors, a maximum throughput in a cell, average throughput in the cell etc. Further, whenever a neighbor gNB is installed or a new service is introduced, many of the manual operations need to be repeated. To resolve the problem, 3gpp has introduced Self-Organizing Networks (SON) techniques in the wireless technologies like NR. The SON is first introduced in 3gpp release 9, in LTE. The SON solutions can be divided into three categories: first is a self-configuration, second is a self-optimization and third is a self-healing. The SON architecture can be a centralized, distributed or a hybrid solution. Mobility Robustness Optimization (MRO) is the SON technique which is used to optimize various parameters related to mobility.

According to 3gpp specifications like TS 38.300 V17.3.0. The MRO aims at detecting and enabling correction for connection failure due to intra-system or inter-system mobility, Inter-system Unnecessary HO (too early inter-system HO from NR to E-UTRAN with no radio link failure), and Inter-system HO ping-pong. The MRO provides means to distinguish the above problems from NR coverage related problems and other problems, not related to mobility.

One of the functions of the MRO is to detect a sub-optimal successful handover event. The aim is to identify underlying conditions during successful ordinary handovers, successful DAPS handovers, or successful conditional handovers. For analysis of successful handover, the UE supports Successful Handover Report (SHR) based on configuration by network (for e.g. through IE successHO-Config as defined in 3gpp Technical Specification TS 38.331 in NR), if received, and makes the SHR available to the network. Upon retrieval of the SHR, the receiving node analyse whether the mobility configuration needs adjustment. SHR is supported for Layer 3 mobility. successHO-Config is given as follows: SuccessHO-Config-r17:: =

```
SEQUENCE {
  thresholdPercentageT304-r17 ENUMERATED {p40, p60, p80, spare5, spare4,
spare3, spare2, spare1} OPTIONAL, --Need R
  thresholdPercentageT310-r17 ENUMERATED {p40, p60, p80, spare5, spare4,
spare3, spare2, spare1} OPTIONAL, --Need R
  thresholdPercentageT312-r17 ENUMERATED {p20, p40, p60, p80, spare4, spare3,
spare2, spare1} OPTIONAL, --Need R
  sourceDAPS-FailureReporting-r17 ENUMERATED {true} OPTIONAL, --Need R
  }
```

Thus, it is desired to address the above-mentioned disadvantages or other shortcomings or at least provide a useful alternative.

### DISCLOSURE OF INVENTION

### Technical Problem

In line with development of the communication systems, there is a need for method of optimizing lower triggered mobility (LTM).

The technical subjects pursued in the disclosure may not be limited to the above mentioned technical subjects, and other technical subjects which are not mentioned may be clearly understood, through the following descriptions, by those skilled in the art to which the disclosure pertains.

The principal object of the embodiments herein is to optimize LTM in a telecommunication network system.

Another object of the invention is to optimize Lower Triggered Mobility (LTM) in NR through successful handover report and Radio Link Failure (RLF) report.

Another object of the invention is to handle successful handover configuration during RLF.

Another object of the invention is to ensure enhancement in RLF report for specific cause for LTM cell switch.

Another object of the invention is to ensure enhancement in RLF report with LTM related parameters.

Another object of the invention is to provide a method for configuring and evaluating SHR thresholds for LTM.

Another object of the invention is to provide a method for performing SHR reporting for LTM

Another object of the invention is to handle SHR for L3 mobility at the time of LTM cell switch.

### Solution to Problem

Embodiments herein optimizes LTM in telecommunication network system. UE (101) receives SHR configuration of at least one of a source cell and target cell in signalling message from network apparatus (201) for reporting successful handover. Further, UE determines whether the SHR configuration is for LTM or Layer 3 (L3) mobility. Further, UE determines whether one or more SHR conditions for LTM is met based on the SHR configuration. Further, the UE stores, SHR for the LTM, when the one or more SHR conditions for LTM is met. Further, the UE transmits the SHR to network apparatus upon successful handover of the UE from the source cell to the target cell.

In one aspect, the objectives are achieved by providing a method for optimizing Lower Triggered Mobility (LTM) in a telecommunication network system. The method includes receiving, by a User Equipment (UE), a SHR configuration of at least one of a source cell and a target cell in a signalling message from a network apparatus for reporting successful handover. Further, the method includes determining, by the UE, whether the SHR configuration is for LTM or Layer 3 (L3) mobility. Further, the method includes determining, by the UE, whether one or more SHR conditions for LTM is met based on the SHR configuration of the at least one of the source cell and the target cell, when the SHR configuration is for LTM. Further, the method includes storing, by the UE, SHR for the LTM, when the one or more SHR conditions for LTM is met. The SHR comprises at least one of LTM measurements, cause of SHR, source cell-id, and target cell-id. Further, the method includes transmitting, by the UE, the SHR to the network apparatus upon successful handover of the UE from the source cell to the target cell.

In an embodiment, the SHR configuration of the source cell comprises at least one of a first threshold percentage for a first timer and a second threshold percentage for a second timer.

In an embodiment, the first timer is configured with a first timer value and the second timer is configured with a second timer value in the signalling message.

In an embodiment, the SHR configuration of the target cell comprises a third threshold percentage for a third timer.

In an embodiment, the third timer is configured with a third timer value in the signalling message.

In an embodiment, the signalling message is at least one of a Radio Resource Control (RRC) reconfiguration message and a RRC resume message.

In an embodiment, the method of storing SHR for the LTM, when the one or more SHR conditions for LTM is met comprises determining, by the UE, whether ratio between elapsed time of the first timer and the first timer value greater than the first threshold percentage. Further, the method includes storing, by the UE, SHR for the LTM, when the ratio between elapsed time of the first timer and the first timer value is greater than the first threshold percentage.

In an embodiment, the method of storing SHR for the LTM, when the one or more SHR conditions for LTM is met comprises determining, by the UE, whether ratio between elapsed time of the second timer at the UE and the second timer value is greater than the second threshold percentage. Further, the method includes storing, by the UE, SHR for the LTM, when the ratio between elapsed time of the second timer at the UE and the second timer value is greater than the second threshold percentage.

In an embodiment, the method of storing the SHR for the LTM, when the one or more SHR conditions for LTM is met comprises determining, by the UE, whether ratio between elapsed time of the third timer at the UE and the third timer value is greater than the third threshold percentage. Further, the method includes storing, by the UE, the SHR for the LTM, when the ratio between elapsed time of the third timer at the UE and the third timer value is greater than the third threshold percentage.

In an embodiment, the method includes releasing, by the UE, the SHR configuration of the at least one of the source cell and the target cell, when the SHR configuration is not for the LTM and the cell switch is for Master Cell Group (MCG).

In an embodiment, the LTM measurements is at least one of a Reference Signal Received Power (RSRP) measurements, a Signal to Interference and Noise Ratio (SINR) measurements, or Reference Signal Received Quality (RSRQ) measurements.

In an embodiment, the method includes determining, by the UE, whether the LTM measurement is configured for the UE and at least one of radio link failure, handover failure or LTM failure has occurred at the UE. Further, the method includes logging and transmitting to the network apparatus, by the UE, RLF report including the LTM measurements and a cause for the at least one of the radio link failure, handover failure or LTM failure, when the UE is configured with LTM measurement and the at least one of radio link failure, handover failure or LTM failure has occurred.

In an embodiment, the SHR comprises at least one of LTM measurements of source cell, target cell and neighbor cells, cause of SHR, Cell Global identifier (CGI) of the source cell or physical cell identifier (PCI) and New Radio Absolute Radio Frequency Channel Number (NR-ARFCN) of the source cell when CGI of the source cell is not available, Cell Global identifier (CGI) of the target cell or physical cell identifier (PCI) and New Radio Absolute Radio Frequency Channel Number (NR-ARFCN) of the target cell when CGI of the target cell is not available, C-RNTI (Cell-Radio Network Temporary Identifier), Location information, whether neighbor cell is a LTM candidate cell, L3 measurement results for source cell, target cell and neighbor cells, PLMN (Public Land Mobilie Network) identifier, Standalone Non-Public Network (SNPN) identifier and random access related information.

Accordingly, the embodiment herein is to provide a method for optimizing Lower Triggered Mobility (LTM) in a telecommunication network system. The method includes transmitting, by a network apparatus, a SHR configuration of at least one of a source cell and a target cell in a signalling message for reporting successful handover. Further, the method includes receiving, by the network apparatus, a SHR upon successful handover of the UE from the source cell to the target cell. Further, the method includes transmitting, by the network apparatus, the SHR to at least one of Distributed Unit (DU) or Operations, Administration and Management module (OAM) for optimization of network resources.

Accordingly, the embodiment herein is to provide a UE for optimizing LTM through Successful Handover Report (SHR) in a telecommunication network system. The UE comprises a processor and a LTM controller communicatively coupled to the processor. The LTM controller receives a SHR configuration of at least one of a source cell and a target cell in a signalling message from a network apparatus for reporting successful handover. Further, the LTM controller determines whether the SHR configuration is for LTM or Layer 3 (L3) mobility. Further, the LTM controller determines whether one or more SHR conditions for LTM is met based on the SHR configuration of the at least one of the source cell and the target cell, when the SHR configuration is for LTM. Further, the LTM controller stores SHR for the LTM, when the one or more SHR conditions for LTM is met, wherein the SHR comprises at least one of LTM measurements, cause of SHR, source cell-id, and target cell-id. Further, the LTM controller transmit the SHR to the network apparatus upon successful handover of the UE from the source cell to the target cell.

Accordingly, the embodiment herein is to provide a network apparatus for optimizing Lower Triggered Mobility (LTM) in a telecommunication network system. The network apparatus comprises a processor and a LTM controller communicatively coupled to the processor. The LTM controller transmits a SHR configuration of at least one of a source cell and a target cell in a signalling message for reporting successful handover. Further, the LTM controller receives a SHR upon successful handover of the UE from the source cell to the target cell. Further, the LTM controller transmits the SHR to at least one of Distributed Unit (DU) or Operations, Administration and Management module (OAM) for optimization of network resources.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications be made within the scope of the embodiments herein.

### Advantageous Effects of Invention

The present disclosure provides an effective and efficient method for optimizing lower triggered mobility (LTM). Advantageous effects obtainable from the disclosure may not be limited to the above mentioned effects, and other effects which are not mentioned may be clearly understood, through the following descriptions, by those skilled in the art to which the disclosure pertains.

### BRIEF DESCRIPTION OF DRAWINGS

These and other features, aspects, and advantages of the present embodiments are illustrated in the accompanying drawings, throughout which like reference letters indicate corresponding parts in the various figures. The embodiments herein will be better understood from the following description with reference to the drawings, in which:

FIG. 1 is a block diagram that illustrates a UE for optimizing LTM in a telecommunication network system, according to the embodiment as disclosed herein;

FIG. 2 is a block diagram that illustrates a network apparatus for optimizing LTM in a telecommunication network system, according to the embodiment as disclosed herein;

FIG. 3 is a flow diagram that illustrates a method for optimizing LTM by UE in a telecommunication network system, according to the embodiment as disclosed herein;

FIG. 4 is a flow diagram that illustrates a method for optimizing LTM by network apparatus in a telecommunication network system, according to the embodiment as disclosed herein;

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the invention. Furthermore, the elements may have been represented in the drawing by conventional symbols, and the drawings may show only those specific details that are pertinent to the understanding the embodiments of the invention so as not to obscure the drawing with details that will be readily apparent to those of ordinary skill in the art having benefit of the description herein.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples are not be construed as limiting the scope of the embodiments herein.

As is traditional in the field, embodiments are described and illustrated in terms of blocks that carry out a described function or functions. These blocks, which referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and optionally be driven by firmware and software. The circuits, for example, be embodied in one or more semiconductor chips, or on substrate supports such as printed circuit boards and the like. The circuits constituting a block be implemented by dedicated hardware, or by a processor (e.g., one or more programmed microprocessors and associated circuitry), or by a combination of dedicated hardware to perform some functions of the block and a processor to perform other functions of the block. Each block of the embodiments be physically separated into two or more interacting and discrete blocks without departing from the scope of the proposed method. Likewise, the blocks of the embodiments be physically combined into more complex blocks without departing from the scope of the proposed method.

The accompanying drawings are used to help easily understand various technical features and it is understood that the embodiments presented herein are not limited by the accompanying drawings. As such, the proposed method is construed to extend to any alterations, equivalents and substitutes in addition to those which are particularly set out in the accompanying drawings. Although the terms first, second, etc. used herein to describe various elements, these elements are not be limited by these terms. These terms are generally used to distinguish one element from another.

Accordingly, the embodiments disclose a method for optimizing LTM in a telecommunication network system. The method includes receiving, by a User Equipment (UE), a SHR configuration of at least one of a source cell and a target cell in a signalling message from a network apparatus for reporting successful handover. Further, the method includes determining, by the UE, whether the SHR configuration is for LTM or Layer 3 (L3) mobility. Further, the method includes determining, by the UE, whether one or more SHR conditions for LTM is met based on the SHR configuration of the at least one of the source cell and the target cell, when the SHR configuration is for LTM. Further, the method includes storing, by the UE, SHR for the LTM, when the one or more SHR conditions for LTM is met. The SHR comprises at least one of LTM measurements, cause of SHR, source cell-id, and target cell-id. Further, the method includes transmitting, by the UE, the SHR to the network apparatus upon successful handover of the UE from the source cell to the target cell.

Accordingly, the embodiments disclose a method for optimizing Lower Triggered Mobility (LTM) in a telecommunication network system. The method includes transmitting, by a network apparatus, a SHR configuration of at least one of a source cell and a target cell in a signalling message for reporting successful handover. Further, the method includes receiving, by the network apparatus, a SHR upon successful handover of the UE from the source cell to the target cell. Further, the method includes transmitting, by the network apparatus, the SHR to at least one of Distributed Unit (DU) or Operations, Administration and Management module (OAM) for optimization of network resources.

Accordingly, the embodiments disclose a UE for optimizing LTM through Successful Handover Report (SHR) in a telecommunication network system. The UE comprises a processor and a LTM controller communicatively coupled to the processor. The LTM controller receives a SHR configuration of at least one of a source cell and a target cell in a signalling message from a network apparatus for reporting successful handover. Further, the LTM controller determines whether the SHR configuration is for LTM or Layer 3 (L3) mobility. Further, the LTM controller determines whether one or more SHR conditions for LTM is met based on the SHR configuration of the at least one of the source cell and the target cell, when the SHR configuration is for LTM. Further, the LTM controller stores SHR for the LTM, when the one or more SHR conditions for LTM is met, wherein the SHR comprises at least one of LTM measurements, cause of SHR, source cell-id, and target cell-id. Further, the LTM controller transmit the SHR to the network apparatus upon successful handover of the UE from the source cell to the target cell.

Accordingly, the embodiments disclose a network apparatus for optimizing Lower Triggered Mobility (LTM) in a telecommunication network system. The network apparatus comprises a processor and a LTM controller communicatively coupled to the processor. The LTM controller transmits a SHR configuration of at least one of a source cell and a target cell in a signalling message for reporting successful handover. Further, the LTM controller receives a SHR upon successful handover of the UE from the source cell to the target cell. Further, the LTM controller transmits the SHR to at least one of Distributed Unit (DU) or Operations, Administration and Management module (OAM) for optimization of network resources.

Mobility in the NR is described herein according to conventional systems.

In wireless technologies like 5G NR, devices can move across different cells. Mobility is performed using a procedure called cell reselection in RRC_IDLE mode. Till NR R17, mobility is performed using a procedure called handover in RRC_CONNECTED mode. The network controlled mobility applies to the UEs in RRC_CONNECTED. An explicit RRC signaling to be triggered by the gNB in NR is applied. Handover in the NR usually consists of three steps: handover preparation, handover execution and handover completion. The gNB can configure the UE to report measurements and based on the reported measurements or based on the understanding of the network topology, the gNB will send RRC Reconfiguration message to handover the UE to another cell called target cell from source cells. The UE accesses the target cell and sends RRC reconfiguration complete message. In an alternative way introduced in 3gpp NR release 16, the gNB can configure the UE with the conditions for triggering handover and once the conditions are satisfied, the UE can move to target cell and sends the RRC Reconfiguration complete. In all the methods, the UE performs handover by sending layer 3 (RRC) messages which causes considerable signaling overhead and latency issues. During handover, the UE can be configured to apply full configuration during a L3 handover, and if configured UE applies full configuration. Referring to the handover, and conditional handover (CHO) as layer 3 mobility. In case of dual connectivity, the UE can perform PSCellChange or Conditional PSCellChange. In the context of dual connectivity, PSCellChange or Conditional PSCellChange are referred also as layer 3 mobility. i.e. Handover, Conditional Handover, PSCellChange, Conditional PSCellChange etc. refers to L3 mobility. Also refer PSCellChange or Conditional PSCellChange as SCG layer 3 mobility and the handover and CHO as MCG layer 3 mobility in the context of dual connectivity.

In the proposed solution, the 3gpp release 18 is considering Lower layers (L1/L2 layers) Triggered Mobility, also known as LTM to solve this problem. As per 3gpp, the goal of LTM is to enable a serving cell change via L1/L2 signaling, in order to reduce the latency, overhead and interruption time. The network apparatus (such as gNB in NR) can configure the UE with multiple candidate cells to allow fast application of configurations for candidate cells. The network can further send MAC CE or L1 signaling (using cell switch command) to dynamically switch the UE from a source cell to one of the configured candidate cells. Further, LTM can be triggered based on L1 measurements rather than L3 measurements. The UE can receive LTM measurement configuration from gNB which are L1 measurement configuration that provides the UE configuration for measuring, reporting, and contents of reporting or information contained in reporting.

Also, in the proposed solution the 3gpp performs LTM, without reset of lower layers like MAC to avoid data loss and to reduce the additional delay of data recovery wherever it is possible. gNB may provide LTMCandidateConfiguration, i.e. configure LTM candidate cells through one RRCReconfiguration message for a candidate target cell The gNB can further release or modify the candidate configurations. The UE can store the LTM configuration of other candidate cells even after moving to a candidate cell through LTM.

Also, to avoid transmitting a large message over air interface, the gNB can provide the LTM candidate configuration as delta configuration instead of full configuration. The gNB can indicate the UE to use the source cell configuration as the reference for delta configuration or provide the reference configuration explicitly.

The gNB also provide the UE with configuration for performing LTM measurements for different candidate frequencies and candidate cells and reporting based on the performed LTM measurements. The gNB provides reference configuration, L1 measurement configuration and candidate cell configuration in a RRC ASN.1 SEQUENCE used for LTM Configuration.

The proposed solution provides a method for optimizing the LTM in the telecommunication network. The proposed solution enhances the RLF report for specific cause such as LTM switch. Also, the proposed solution enhances the RFL reporting with the LTM measurements. Further, in the proposed solution the network apparatus ensures configuring the UE for SHR with SHR thresholds for LTM. The proposed solution enables the SHR reporting for the LTM by the UE and also manging the contents in the SHR. Also, the proposed solution handles the reporting of the SHR for both the L3 mobility and the LTM.

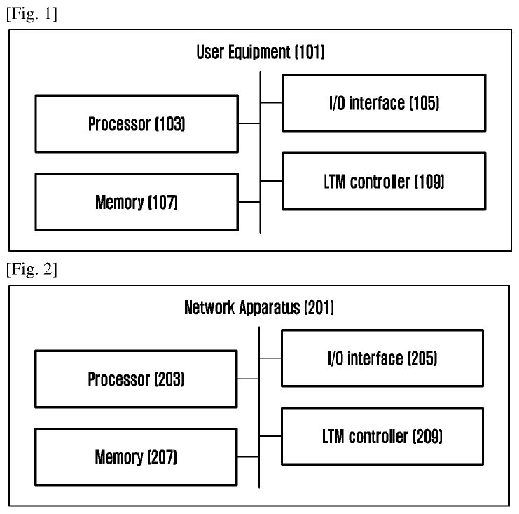

FIG. 1 is a block diagram that illustrates a UE for optimizing LTM in a telecommunication network system, according to the embodiment as disclosed herein.

The User Equipment (UE) (101) includes a processor (103), a memory (107), an I/O interface (105) and a LTM controller (109). The UE (101) can be an end-user device that connects with the network apparatus to access services. For example, the UE (101) can include, but not limited to a mobile phone, a smart phone, tablets, laptops, Internet of Things (IoT) devices. Further, the processor (103) of the UE (101) communicates with the memory (107), the I/O interface (105) and the LTM controller (109). The processor (103) is configured to execute instructions stored in the memory (107) and to perform various processes. The processor (103) can include one or a plurality of processors, can be a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

Further, the memory (107) of the UE (101) includes storage locations to be addressable through the processor (103). The memory (107) is not limited to a volatile memory and/or a non-volatile memory. Further, the memory (107) can include one or more computer-readable storage media. The memory (107) can include non-volatile storage elements. For example, non-volatile storage elements can include magnetic hard discs, optical discs, floppy discs, flash memories, or forms of electrically programmable memories (EPROM) or electrically erasable and programmable (EEPROM) memories. The memory (107) can store the media streams such as audios stream, video streams, haptic feedbacks and the like. Also, the memory (107) of the UE (101) can store several information received the at least one of the network apparatus. For example, the memory can store several information such as SHR configuration of source cell and target cell. The SHR configuration is provided in the signaling message from network apparatus for reporting successful handover.

The I/O interface (105) transmits the information between the memory (107) and external peripheral devices. The peripheral devices are the input-output devices associated with the UE (101). The I/O interface (105) receives several information from the network apparatus. The several information received from the network apparatus can include but not limited to SHR configuration for reporting the successful handover.

The LTM controller (109) communicates with the I/O interface (105) and memory (107) for optimizing LTM in a telecommunication network system. The LTM controller (109) is an innovative hardware that is realized through the physical implementation of both analog and digital circuits, including logic gates, integrated circuits, microprocessors, microcontrollers, memory circuits, passive and active electronic components, as well as optical components. The LTM controller (109) of the UE (101) receives a SHR configuration of at least one of a source cell and a target cell in a signalling message from a network apparatus for reporting successful handover. Further, the LTM controller (109) determines whether the SHR configuration is for LTM or Layer 3 (L3) mobility. Further, the LTM controller (109) determines whether one or more SHR conditions for LTM is met based on the SHR configuration of the at least one of the source cell and the target cell, when the SHR configuration is for LTM. Further, the LTM controller (109) stores SHR for the LTM, when the one or more SHR conditions for LTM is met. The SHR comprises at least one of LTM measurements, cause of SHR, source cell-id, and target cell-id. Further, the LTM controller (109) transmits the SHR to the network apparatus upon successful handover of the UE from the source cell to the target cell.

An example specification (Example. 1) for the configuration and operation of LTM is given as below:

5.3.5.x LTM configuration and execution

| | |
|---|---|
| 5.3.5.x.1 | General |

The UE shall perform the following actions based on a received LTM-CandidateConfig
IE:

| 1> | store the received ltm-ReferenceConfiguration in VarLTM-Config, if present; | |
|---|---|---|
| 1> | if the LTM-CandidateConfig includes the ltm-CandidateToReleaseList: | |
| | 2> | perform the LTM candidate cell release as specified in 5.3.5.x.2; |
| 1> | if the LTM-CandidateConfig includes the ltm-CandidateResetL2-List: | |
| | 2> | add the received ltm-CandidateResetL2-List to VarLTM-Config; |
| 1> | if the LTM-CandidateConfig includes the ltm-Candidate To AddModList: | |
| | 2> | perform the LTM candidate cell addition or reconfiguration as specified in |

5.3.5.x.3;

| | |
|---|---|
| 1> | perform the actions to generate a complete LTM configuration as specified in |
| | 5.3.5.x.4; |

| | |
|---|---|
| NOTE X: | It is up to the UE implementation to postpone the generation of a |

complete LTM configuration until the executing of an LTM cell switch.

| | |
|---|---|
| 5.3.5.x.2 | LTM candidate cell release |

The UE shall:

| 1> | for each ltm-CandidateId in the ltm-Candidate ToReleaseList: | |
|---|---|---|
| | 2> | if the current VarLTM-Config includes an ltm-Candidate with the given ltm- |

| CandidateId: | |
|---|---|
| 3> | release the ltm-Candidate from VarLTM-Config; |

| | |
|---|---|
| 5.3.5.x.3 | LTM candidate cell addition/modification |

The UE shall:

| 1> | for each ltm-CandidateId in the ltm-Candidate ToAddModList: | |
|---|---|---|
| | 2> | if the current VarLTM-Config includes an ltm-Candidate with the given ltm- |

| | CandidateId: |
|---|---|
| 3> | modify the ltm-Candidate within VarLTM-Config in accordance with the |

received ltm-Candidate;

| | |
|---|---|
| 2> | else: |

| | |
|---|---|
| 3> | add the received ltm-Candidate to VarLTM-Config. |

| | |
|---|---|
| 5.3.5.x.4 | Generation of UE LTM configuration |

The purpose of this procedure is for the UE to generate a complete LTM candidate cell
configuration to be stored and applied only when an indication of an LTM cell switch is
received by lower layers. During the generation of a complete LTM candidate cell
configuration, the current UE configuration shall not be modified.
The UE shall:

| 1> | for each ltm-Candidate in ltm-CandidateConfigList within VarLTM-Config; | |
|---|---|---|
| | 2> | store the ltm-CandidateId included in ltm-Candidate within VarLTM-UE- |
| | | Config; |
| | 2> | if ltm-Candidate includes ltm-ConfigComplete; |

| | |
|---|---|
| 3> | generate a complete LTM candidate cell configuration for the received ltm- |

Candidate according to the actions described in clause 5.3.5.3 and store it in
ue-LTM-Config within VarLTM-UE-Config.

| | |
|---|---|
| 2> | else: |

| | |
|---|---|
| 3> | generate a complete LTM candidate cell configuration by applying ltm- |

Candidate on top of referenceConfiguration according to the actions
described in clause 5.3.5.3 and store it in ue-LTM-Config within VarLTM-
UE-Config.

| | |
|---|---|
| 5.3.5.x.5 | LTM cell switch execution |

Upon the indication by lower layers that an LTM cell switch procedure is triggered, the
UE shall:

| 1> | release/clear all current dedicated radio configuration except for the following: | |
|---|---|---|
| | 2> | if the LTM cell switch is triggered on the MCG: |

| | |
|---|---|
| - | the MCG C-RNTI; |
| - | the AS security configurations associated with the master key; |

| | |
|---|---|
| 2> | else, if the LTM cell switch is triggered on the SCG: |

| | |
|---|---|
| - | the SCG C-RNTI; |
| - | the AS security configurations associated with the secondary key; |

| | - | the SRB1/SRB2 configurations and DRB configurations as configured by |
|---|---|---|
| | | radioBearerConfig or radio BearerConfig2; |
| | - | the UE variables VarLTM-Config and VarLTM-UE-Config. |
| 1> | release/clear all current common radio configuration; | |
| 1> | use the default values specified in 9.2.3 for timers T310, T311 and constants | |
| | N310, N311; | |
| 1> | apply the default L1 parameter values as specified in corresponding physical layer | |
| | specifications except for the following: | |
| | - | parameters for which values are provided in SIB1; |
| 1> | apply the value of the new UE-Identity as the C-RNTI for this cell group according | |
| | to the LTM candidate cell configuration related to the the LTM candidate cell | |
| | configuration identity as received by lower layers; | |
| 1> | configure lower layers in accordance with the received spCellConfigCommon | |
| | according to the LTM candidate cell configuration indicated by lower layers; | |
| 1> | configure lower layers in accordance with the received rach-ConfigDedicated | |
| | according to the LTM candidate cell configuration indicated by lower layers. | |
| 1> | configure the PDCP entity for LTM candidate cell configuration indicated by | |
| | lower layers with state variables continuation as specified in TS 38.323 , and | |
| | with the same security configuration as the PDCP entity for the source cell group; | |
| 1> | stop timer T310 for the corresponding SpCell, if running; | |
| 1> | if this procedure is executed for the MCG: | |
| | 2> | if timer T316 is running: |

| | |
|---|---|
| 3> | stop timer T316; |

| | |
|---|---|
| 1> | stop timer T312 for the corresponding SpCell, if running; |
| 1> | apply the specified BCCH configuration defined in 9.1.1.1 for the target LTM |
| | candidate cell configuration; |
| 1> | acquire the MIB of the target SpCell as indicated in the LTM candidate cell |
| | configuration indicated by lower layers, which is scheduled as specified in TS |
| | 38.213 [13], if applicable; |
| 1> | apply the LTM configuration in UE-LTM-Config within VarLTM-UE-Config |
| | related to the LTM candidate cell configuration identity as received by lower |
| | layers. |
| 1> | submit the RRCReconfigurationComplete message to lower layers for |
| | transmission using the new configuration. |

| | |
|---|---|
| RRCReconfiguration-v1700-Ies ::= | SEQUENCE { |
| otherConfig-v1700 | OtherConfig-v1700 |

OPTIONAL, -- Need M

| | |
|---|---|
| s1-L2RelayUE-Config-r17 | SetupRelease { SL-L2RelayUE-Config-r17 } |

OPTIONAL, -- Need M

| | |
|---|---|
| s1-L2RemoteUE-Config-r17 | SetupRelease { SL-L2RemoteUE-Config-r17 } |

OPTIONAL, -- Need M

| | |
|---|---|
| dedicatedPagingDelivery-r17 | OCTET STRING (CONTAINING Paging) |

OPTIONAL, -- Cond PagingRelay

| | |
|---|---|
| needForGapNCSG-ConfigNR-r17 | SetupRelease {NeedForGapNCSG- |
| ConfigNR-r17} | OPTIONAL, -- Need M |
| needForGapNCSG-ConfigEUTRA-r17 | SetupRelease {NeedForGapNCSG- |
| ConfigEUTRA-r17} | OPTIONAL, -- Need M |
| musim-GapConfig-r17 | SetupRelease {MUSIM-GapConfig-r17} |

OPTIONAL, -- Need M

| | |
|---|---|
| ul-GapFR2-Config-r17 | SetupRelease { UL-GapFR2-Config-r17 } |

OPTIONAL, -- Need M

| | |
|---|---|
| scg-State-r17 | ENUMERATED { deactivated } |

OPTIONAL, -- Need N

| | |
|---|---|
| appLayerMeasConfig-r17 | AppLayerMeasConfig-r17 |

OPTIONAL, -- Need M

| | |
|---|---|
| ue-TxTEG-RequestUL-TDOA-Config-r17 | SetupRelease {UE-TxTEG- |
| RequestUL-TDOA-Config-r17} | OPTIONAL, -- Need M |
| nonCriticalExtension | RRCReconfiguration-v18xy |

OPTIONAL
}

| | |
|---|---|
| RRCReconfiguration-v18xy-Ies ::= | SEQUENCE { |
| ltm-CandidateConfig-r18 | SetupRelease {LTM-CandidateConfig-r18} |

OPTIONAL, -- Need M

| | |
|---|---|
| nonCriticalExtension | SEQUENCE { } |

```
OPTIONAL
}
Ltm-CandidateConfig
  Configuration of LTM candidate cell(s), reference configuration for LTM cell(s) and
    sets of cells in which full L2 reset is applied upon an LTM cell switch.
-- Serving cell specific MAC and PHY parameters for a SpCell:
```

| SpCellConfig ::= | SEQUENCE { | |
|---|---|---|
| servCellIndex | ServCellIndex | OPTIONAL, |

-- Cond SCG

| | |
|---|---|
| reconfigurationWithSync | ReconfigurationWithSync |

OPTIONAL, -- Cond ReconfWithSync

| | |
|---|---|
| rlf-TimersAndConstants | SetupRelease { RLF-TimersAndConstants } |

OPTIONAL, -- Need M

| | |
|---|---|
| rlmInSyncOutOfSyncThreshold | ENUMERATED {n1} |

OPTIONAL, -- Need S

| | |
|---|---|
| spCellConfigDedicated | ServingCellConfig |

```
OPTIONAL, -- Need M
  ...,
  [[
```

| | |
|---|---|
| lowMobilityEvaluationConnected-r17 | SEQUENCE { |
| s-SearchDeltaP-Connected-r17 | ENUMERATED {dB3, dB6, dB9, dB12, |

dB15, spare3, spare2, spare1},

| | |
|---|---|
| t-SearchDeltaP-Connected-r17 | ENUMERATED {s5, s10, s20, s30, s60, s120, |

s180, s240, s300, spare7, spare6, spare5,
spare4, spare3, spare2, spare1}

| | |
|---|---|
| } | OPTIONAL, -- Need R |

| | |
|---|---|
| goodServingCellEvaluationRLM-r17 | GoodServingCellEvaluation-r17 |

OPTIONAL, -- Need R

| | |
|---|---|
| goodServingCellEvaluationBFD-r17 | GoodServingCellEvaluation-r17 |

OPTIONAL, -- Need R

| | |
|---|---|
| deactivatedSCG-Config-r17 | SetupRelease { DeactivatedSCG-Config-r17 } |

OPTIONAL -- Cond SCG-Opt
]],

| | |
|---|---|
| ltmCellSwitchInfo | SetupRelease { LtmCellSwitchInfo } |

OPTIONAL -- Need M
}

| | |
|---|---|
| LtmCellSwitchInfo-r18 ::= | SEQUENCE { |
| spCellConfigCommon | ServingCellConfigCommon |

OPTIONAL, -- Need M

| | |
|---|---|
| newUE-Identity | RNTI-Value, |
| rach-ConfigDedicated | CHOICE { |
| uplink | RACH-ConfigDedicated, |
| supplementaryUplink | RACH-ConfigDedicated |

| | |
|---|---|
| } | OPTIONAL, -- Need N |

```
}
ltmCellSwitchInfo
  This field contains necessary information for the UE to execute an LTM cell
    switch procedure in case this cell is a LTM target cell.
- LTM-CandidateConfig
The IE LTM-CandidateConfig is used to provide LTM candidate cell configuration.
              LTM-CandidateConfig information element
-- ASN1START
-- TAG-LTM-CANDIDATECONFIG-START
```

| | |
|---|---|
| LTM-CandidateConfig-r18 ::= | SEQUENCE { |
| lte-ReferenceConfiguration-r18 | OCTET STRING (CONTAINING |
| RRCReconfiguration), | OPTIONAL, -- Cond FirstLTM-Candidate |
| ltm-CandidateToReleaseList-r18 | LTM-CandidateToReleaseList-r18 |

OPTIONAL, -- Need N

| | |
|---|---|
| ltm-CandidateToAddModList-r18 | LTM-CandidateToAddModList-r18 |

OPTIONAL, -- Need N

| | |
|---|---|
| ltm-CandidateResetL2-List-r18 | SetupRelease { LTM-CandidateResetL2-List- |

r18 } OPTIONAL -- Need M
...
}
LTM-CandidateToReleaseList-r18 ::= SEQUENCE (SIZE (1..maxNrofCellsLTM-r18))

| | |
|---|---|
| OF LTM-Candidateld-r18 | OPTIONAL -- Need N |

LTM-CandidateToAddModList-r18 ::= SEQUENCE (SIZE (1..maxNrofCellsLTM-
r18)) OF LTM-Candidate-r18

| | |
|---|---|
| LTM-Candidate-r18 ::= | SEQUENCE { |
| ltm-CandidateId-r18 | LTM-CandidateId-r18, |
| ltm-Config-r18 | OCTET STRING (CONTAINING |

RRCReconfiguration),

| | |
|---|---|
| ltm-ConfigComplete-r18 | ENUMERATED {true} |

OPTIONAL -- Need R
...
}
LTM-CandidateResetL2-List-r18 ::= SEQUENCE (SIZE (1..maxNrofCellsLTM-r18))
OF LTM-CandidateId-r18
Editor's Note: FFS on whether the LTM-CandidateNoResetL2-List field should include
separate reset flags for MAC, RLC, and PDCP recovery.
-- TAG-LTM-CANDIDATECONFIG-STOP
-- ASN1STOP

LTM-CandidateConfig field descriptions
ltm-Config
This field includes an RRCReconfiguration message used to configure an LTM
candidate cell. This field shall include the CellGroupConfig IE, and it may also
include the RadioBearerConfig IE, and MeasConfig IE.
ltm-ConfigComplete
This field indicates whether the LTM candidate cell configuration within ltm-Config
is a complete configuration and thus the UE shall not use the LTM reference
configuration within the field lte-ReferenceConfiguration.
ltm-CandidateNoResetL2-List
This field includes a list of LTM candidate cell identifiers for which the full L2 reset
is needed upon an LTM cell switch.
ltm-ReferenceConfiguration
This field includes an RRCReconfiguration message used to configure a reference
configuration for LTM.

| Conditional Presence | Explanation |
|---|---|
| FirstLTM-Candidate | This field is mandatory present upon the first configuration |
| | of LTM-CandidateConfig. Otherwise, the field is optionally |
| | present, Need M. |

| 7.4 UE variables | |
|---|---|
| - VarLTM-Config | |
| The IE VarLTM-Config is used to store the reference configuration and the LTM | |
| candidate cell configurations. | |
| | VarLTM-Config UE variable |
| -- ASN1START | |
| -- TAG-VARLTM-CONFIG-START | |
| VarLTM-Config-r18-IEs ::= SEQUENCE { | |
| ltm-ReferenceConfiguration-r18 | OCTET STRING (CONTAINING |
| RRCReconfiguration), | |
| ltm-CandidateList-r18 | LTM-CandidateList-r18 |
| ltm-CandidateResetL2-List-r18 | LTM-CandidateResetL2-List-r18 |
| } | |
| LTM-CandidateList-r18 ::= SEQUENCE (SIZE (1..maxNrofCellsLTM-r18)) OF LTM- | |
| Candidate-r18 | |
| LTM-CandidateResetL2-List-r18 ::= SEQUENCE (SIZE (1..maxNrofCellsLTM-r18)) | |
| OF LTM-Candidate-r18 | |
| -- TAG-VARLTM-CONFIG-STOP | |
| -- ASN1STOP | |
| - VarLTM-UE-Config | |
| The IE VarLTM-UE-Config is used to store the generated UE configuration related to | |
| the received LTM candidate cell configurations. | |
| | VarLTM-UE-Config UE variable |
| -- ASN1START | |
| -- TAG-VARLTM-CONFIG-START | |
| VarLTM-UE-Config-r18-IEs ::= SEQUENCE { | |
| Ue-ltm-ConfigCandidateList-r18 | UE-LTM-ConfigCandidateList-r18 |
| } | |
| UE-LTM-ConfigCandidateList-r18 ::= SEQUENCE (SIZE (1..maxNrofCellsLTM-r18)) | |
| OF UE-LTM-Config-r18 | |
| UE-LTM-Candidate-r18 ::= | SEQUENCE { |
| ltm-CandidateId-r18 | LTM-CandidateId-r18, |
| ue-LTM-Config-r18 | OCTET STRING, |

}
-- TAG-VARLTM-CONFIG-STOP
-- ASN1STOP

The LTM cell switch is supervised by a timer. This timer Tcellswitch is started when the UE (101) receives cell switch command and is stopped once the cell switch is completed. In an option, Tcellswitch is defined as a new timer. In another option, existing NR RRC timer T304 can be used for supervising LTM cell switch and all the embodiments for Tcellswitch in the disclosure are applicable for T304 when the Tcellswitch is used for LTM, such as supervising LTM cell switch. The Tcellswitch may be described based on following characteristics:
1. The UE starts the Tcellswitch, upon reception of the LTM cell switch MAC CE;
2. The UE stops the Tcellswitch, upon successful completion of LTM cell switch;
3. If the Tcellswitch for MCG expires, the UE may declare LTM failure and initiate RRC re-establishment;
4. Tcellswitch is RRC layer timer.

LTM measurements:

The UE (101) can be configured by the gNB (herein after network apparatus is interchangeably used as gNB) with different measurement configurations for both layer 3 mobility (for e.g. using MeasConfig IE in R17 NR) and LTM. The UE (101) which has been configured with measurement configurations for layer3 mobility (Measurements configured/performed/reported for layer 3 mobility for e.g. configured through R17 MeasConfig IE in NR, is here in after referred as L3 measurements) and LTM (Measurements configured/performed/reported for LTM is here in after referred as LTM measurements), performs both L3 measurements and LTM measurements. LTM measurements are L1 measurements.

The L1 measurement report for LTM is reported as periodic report on PUCCH, semi-persistent report on PUCCH/PUSCH, and aperiodic report on PUSCH. Further, L1 measurements can be reported using MAC CE. The reports can be scheduled by gNB or initiated by UE. The gNB can decide for LTM through UL measurements also.

In the proposed method the UE (101) which has been configured with successful handover configuration (such as successHO-Config in NR), releases the successful handover configuration during the execution of LTM cell switch. In an embodiment, upon receiving cell switch command from the network, the UE releases the successful handover configuration. In an embodiment, the release is performed by UE RRC layer upon receiving information from the lower layers (such as MAC) that the lower layers has received cell switch command from the network. In an embodiment, the release is performed when the successful handover configuration is for the logging and reporting of successful L3 mobility. In an embodiment, the release is not performed when the successful handover configuration is for the logging and reporting of successful LTM. In an alternative, embodiment, the release is performed when the successful handover configuration is for the logging and reporting of successful L3 mobility and LTM.

In an embodiment, upon receiving cell switch command triggered on MCG, the UE (101) releases the successful handover configuration, configured for L3 mobility. In an embodiment, upon receiving cell switch command triggered on SCG, UE (101) keeps the successful handover configuration, configured for L3 mobility.

In an embodiment, upon receiving cell switch command from the network (and triggered on MCG), the UE (101) releases the successful handover configuration configured for L3 mobility configured by the source cell.

In an embodiment, upon receiving cell switch command from the network (and triggered on MCG), the UE (101) releases the successful handover configuration, configured for L3 mobility configured by the source cell and the T304 threshold configured by the target cell.

In an embodiment, upon receiving cell switch command from the MCG, the UE (101) releases the successful handover configuration, configured for L3 mobility, configured by the source cell and the T304 threshold configured by the target cell.

In an embodiment, the UE (101) which includes the measurements for the neighbour cell in SHR also includes whether the neighbor cell is a LTM candidate cell.

An example sequence capturing some of the embodiments in TS 38.331 is given below:

| | |
|---|---|
| 5.3.5.x.5 | LTM cell switch execution |

Upon the indication by lower layers that an LTM cell switch procedure is triggered, the UE
shall:

| 1> | release/clear all current dedicated radio configuration except for the following: | |
|---|---|---|
| | 2> | if the LTM cell switch is triggered on the MCG: |

| | |
|---|---|
| - | the MCG C-RNTI; |
| - | the AS security configurations associated with the master key; |

| | |
|---|---|
| 2> | else, if the LTM cell switch is triggered on the SCG: |

| | |
|---|---|
| - | the SCG C-RNTI; |
| - | the AS security configurations associated with the secondary key; |

| | - | the SRB1/SRB2 configurations and DRB configurations as configured by |
|---|---|---|
| | | radioBearerConfig or radioBearerConfig2; |
| | - | the UE variables VarLTM-Config and VarLTM-UE-Config. |
| 1> | release/clear all current common radio configuration; | |
| 1> | use the default values specified in 9.2.3 for timers T310, T311 and constants N310, | |
| | N311; | |
| 1> | apply the default L1 parameter values as specified in corresponding physical layer | |
| | specifications except for the following: | |
| | - | parameters for which values are provided in SIB1; |
| 1> | apply the value of the newUE-Identity as the C-RNTI for this cell group according to | |
| | the LTM candidate cell configuration related to the the LTM candidate cell | |
| | configuration identity as received by lower layers; | |
| 1> | configure lower layers in accordance with the received spCellConfigCommon | |
| | according to the LTM candidate cell configuration indicated by lower layers; | |
| 1> | configure lower layers in accordance with the received rach-ConfigDedicated | |
| | according to the LTM candidate cell configuration indicated by lower layers. | |
| 1> | configure the PDCP entity for LTM candidate cell configuration indicated by lower | |
| | layers with state variables continuation as specified in TS 38.323 [5], and with the | |
| | same security configuration as the PDCP entity for the source cell group; | |
| 1> | stop timer T310 for the corresponding SpCell, if running; | |
| 1> | if this procedure is executed for the MCG: | |
| | 2> | release successHO-Config configured by the source PCell and |
| | | thresholdPercentageT304 if configured by the target PCell. |

In an embodiment the UE (101) which has been configured with successful handover configuration (such as successHO-Config in NR), releases the successful handover configuration when the LTM cell switch is successful.

In an embodiment the UE (101) which has been configured with successful handover configuration (such as successHO-Config in NR), releases the successful handover configuration when the LTM cell switch has failed.

In an embodiment the UE (101) which has been configured with successful handover configuration (such as successHO-Config in NR) for L3 mobility, releases the successful handover configuration when the LTM cell switch is successful.

In an embodiment the UE (101) which has been configured with successful handover configuration (such as successHO-Config in NR) for L3 mobility, releases the successful handover configuration when the LTM cell switch has failed.

In an alternative embodiment the UE (101) which has been configured with successful handover configuration (such as successHO-Config in NR) for L3 mobility, keeps the successful handover configuration when the LTM cell switch is successful or has failed.

In an embodiment, the UE (101) which is configured with LTM candidate cells stores the LTM measurements of those candidate cells, if available in the successful handover report for L3 mobility.

In an embodiment, the UE (101) which is configured with LTM candidate cells stores the LTM measurements, if available in the successful handover report for L3 mobility, if there is no L3 measurements available for those candidate cells. In an embodiment, a UE which is configured with LTM candidate cells stores the LTM measurements, if available in the successful handover report for L3 mobility, if there is no L3 measurement object configured for those cells (configured for the corresponding frequency).

In an embodiment, the UE (101) includes the latest LTM measurements in the SHR for L3 mobility. In an embodiment, the UE sends the average of LTM measurements over a specific period of time to the network in SHR for L3 mobility. In an embodiment, network configures the UE with a filter for reporting the applicable LTM measurements in the SHR. UE filters the LTM measurements based on the configured filter. In an embodiment, the LTM measurements can be one of the periodic measurements, aperiodic measurements, semi periodic measurements or event based measurements performed by the UE as configured by gNB for LTM.

In an embodiment, the LTM measurements included in SHR are RSRP (Reference Signal Received Power) measurements. In an embodiment, the LTM measurements included in SHR for L3 mobility are Signal to Interference and Noise Ratio (SINR) measurements. In an embodiment, the LTM measurements included in SHR for L3 mobility are Reference Signal Received Quality (RSRQ) measurements.

The UE (101) configured with both LTM and L3 measurements for the same cell includes only L3 measurements in the SHR for L3 mobility. In an alternate embodiment, the UE configured with both LTM and L3 measurements for the same cell includes both LTM and L3 measurements in the SHR for L3 mobility. In an alternate embodiment, the UE configured with both LTM and L3 measurements for the same cell includes LTM measurements in the SHR for L3 mobility.

Successful Handover Report for LTM:

In an embodiment the UE (101) receives from the network apparatus (such as gNB) a configuration for reporting the successful handover report for LTM (configuration is referred as “successful LTM report configuration” in the disclosure). In the embodiment, the successful LTM report configuration in NR using the RRC IE successHO-Config-r17. In an embodiment, the configuration is received using the new NR IE. In an embodiment, for NR, the configuration is received within RRC IE OtherConfig.

In an embodiment, the successful LTM report configuration includes a threshold percentage for timers T310 (Timer 310 is interchangeably used as first timer) and T312 (Timer T312 is interchangeably used as second timer). In an embodiment, successful LTM report configuration is provided in RRC messages such as RRC Reconfiguration and RRC Resume. In an embodiment, the threshold percentage for timer T310 (first threshold percentage is interchangeably used as threshold percentage for timer T310) for LTM as mentioned above is configured using NR RRC IE thresholdPercentageT310. In an embodiment, the threshold percentage for timer T310 for LTM as mentioned above is configured using a new NR RRC IE.

In an embodiment, if the ratio between the value of the elapsed time of the timer T310 and the configured value of the timer T310, is greater than threshold percentage for timer T310 for LTM as included in the successful LTM report configuration, the UE (101) stores the successful handover report for LTM. In an embodiment, a NR UE (101) sets t310-cause in shr-Cause as true in this case.

In an embodiment, if the ratio between the value of the elapsed time of the timer T312 and the configured value of the applicable timer T312, is greater than threshold percentage for timer T312 (second threshold percentage is interchangeably used as threshold percentage for timer T312) for LTM as included in the successful LTM report configuration, UE (101) stores the successful handover report for LTM. In an embodiment, a NR UE (101) sets t312-cause in shr-Cause as true in this case.

In an embodiment, the threshold percentage for T310, T312 in successful LTM report configuration included some of the values as defined below:
thresholdPercentageT310-r17 ENUMERATED {p40, p60, p80, spare5, spare4, spare3, spare2, spare1} OPTIONAL,—Need R

thresholdPercentageT312-r17 ENUMERATED {p20, p40, p60, p80, spare4, spare3, spare2, spare1} OPTIONAL,—Need R

(p20 means 20 percentage, p40 means 40 percentage, p60 means 60 percentage, p80 means 80 percentage and so on)

In an embodiment, threshold percentage for T310 (threshold percentage for T310 is interchangeably used as first threshold percentage) and T312 (threshold percentage for T312 is interchangeably used as second threshold percentage) in successful LTM report configuration are configured by the source cell. In an embodiment, threshold percentage for T310 and T312 in successful LTM report configuration are included in the RRC message generated by the source cell.

In an embodiment, threshold may be an absolute number such as duration of T310 or duration of T312 instead of the percentage.

In an embodiment, the successful LTM report configuration includes a threshold for the timer Tcellswitch (timer Tcellswitch is interchangeably used as third timer). In an embodiment, the successful LTM report configuration includes a threshold percentage for timer Tcellswitch (threshold percentage for timer Tcellswitch is interchangeably used as third threshold percentage for a third timer) (the threshold percentage may be referred to as thresholdPercentageTcellswitch in this invention). In an embodiment, the successful LTM report configuration for MCG includes the threshold percentage for timer Tcellswitch, thresholdPercentageTcellswitch. In an embodiment, thresholdPercentageTcellswitch is set by the target gNB and is included in target cell's RRC configuration message. In an embodiment, thresholdPercentageT cellswitch is configured in the LTM candidate configuration (such as LTM-Candidate-r18 in the background). In an embodiment thresholdPercentageTcellswitch includes one or more of the following values: 20 percentage, 40 percentage, 60 percentage and 80 percentage. In an embodiment thresholdPercentageTcellswitch includes the following values: 40 percentage, 60 percentage and 80 percentage.

In an embodiment, if the ratio between the value of the elapsed time of the timer Tcellswitch and the configured value of the timer Tcellswitch, is greater than thresholdPercentageTcellswitch as included in the successful LTM report configuration, UE (101) stores the successful handover report for LTM. In an embodiment, the UE (101) stores the successful handover cause (shr-cause) is due to tcellswitch. In an embodiment, UE sets tcellswitch-cause in shr-Cause as true in this case.

In an embodiment, the criteria for threshold matching within the successful LTM report configuration is based on “greater than or equal to” than “greater than”.

In an embodiment, the UE (101) which is configured with LTM candidate cells or LTM measurements stores the available LTM measurements, while storing the successful handover report.

In an embodiment, the UE (101) includes the latest LTM measurements in the SHR for LTM. In an embodiment, the latest measurements is the last measurements taken. In an embodiment, the latest measurements is the last measurements reported. In an embodiment, UE sends the average of LTM measurements over a specific period of time to the network in SHR for LTM. In an embodiment, LTM measurements can be one of the periodic measurements, aperiodic measurements, semi periodic measurements or event based measurements performed by UE as configured by gNB for LTM.

In an embodiment, the LTM measurements included in SHR are RSRP (Reference Signal Received Power) measurements. In an embodiment, the LTM measurements included in SHR for LTM are SINR (Signal to Interference and Noise Ratio) measurements. In an embodiment, the LTM measurements included in SHR for LTM are RSRQ (Reference Signal Received Quality) measurements.

The UE (101) configured with both LTM and L3 measurements for the same cell includes only L3 measurements in the SHR for LTM. In an alternate embodiment, the UE (101) configured with both LTM and L3 measurements for the same cell includes both LTM and L3 measurements in the SHR for LTM. In an alternate embodiment, the UE (101) configured with both LTM and L3 measurements for the same cell includes LTM measurements in the SHR for LTM.

In an embodiment, the above embodiments can be captured in 3gpp specification TS 38.331 as below example embodiments. In the below section same variable name is considered for successful handover reporting for LTM and L3 handover and successful handover reporting configuration for LTM and L3 handover.

In an embodiment, upon receiving cell switch command from the network, the UE (101) keeps the successful handover configuration configured for LTM. Configured T310/T312 thresholds in the successful handover configuration will be used again if there is another mobility from the same source cell. Configured Tcellswitch threshold in the successful handover configuration will be used again if there is another mobility to the same target cell.

In an embodiment, thresholdPercentageTcellswitch can be configured by the gNB in the LTM reference configuration. In an embodiment, thresholdPercentageTcellswit ch can be configured by the gNB in the LTM candidate cell configuration. In an embodiment, thresholdPercentageTcellswitch can be configured by the gNB in any RRC Reconfiguration message.

In an embodiment, the UE (101) configured for success handover reporting for LTM logs and reports the following information as shown in below Table 2:

TABLE 2
Fields included in the Successful Handover Report for L3 handover and LTM
by the UE

c-RNTI
This field indicates the C-RNTI assigned by the target PCell of the LTM or
handover for which the successful HO report was generated.
measResultListNR
This field refers to the last measurement results taken in the neighboring NR
Cells when a successful LTM or handover
is executed.
LTMmeasResultListNR
This field refers to the last LTM measurement results taken in the neighboring
NR Cells when a successful LTM or handover
is executed.
shr-Cause
This field is used to indicate the cause of the successful HO report.
sourceCellMeas
This field refers to the last measurement results taken in the source PCell of a
handover or LTM in which the successful handover
or LTM triggers the SuccessHO-Report.
LTMsourceCellMeas
This field refers to the last LTM measurement results taken in the source
PCell of a handover or LTM
in which the successful handover triggers the SuccessHO-Report.
sourcePCellId
This field is used to indicate the source PCell of a handover or LTM in which
the successful handover or LTM
triggers the SuccessHO-Report.
targetCellId
This field is used to indicate the target PCell of a handover or LTM in which
the successful handover or LTM
triggers the SuccessHO-Report.
targetCellMeas
This field refers to the last measurement results taken in the target PCell of a
handover or LTM
in which the successful handover triggers the SuccessHO-Report.
LTMtargetCellMeas
This field refers to the last LTM measurement results taken in the target PCell
of a handover or LTM
in which the successful handover triggers the SuccessHO-Report.
upInterruptionTimeAtHO
This field is used to indicate the time elapsed between the time of arrival of
the last PDCP PDU received from the source cell for any data radio bearer
and the time of arrival of the first non-duplicate PDCP PDU received from the
target cell for any data radio bearer, and it is measured at the time of arrival of
the first non-duplicate PDCP PDU received from the target cell for any data
radio bearer. The field is set only in case of DAPS handover or DAPS LTM.
Value in milliseconds. The maximum value 1023 means 1023ms or longer.

| | |
|---|---|
| 5.7.10.6 | Actions for the successful handover report determination |

The UE shall for the PCell:

| | |
|---|---|
| 1> | if the ratio between the value of the elapsed time of the timer T304 and |
| | the configured value of the timer T304, included in the last applied |
| | RRCReconfiguration message including the reconfigurationWithSync, is |
| | greater than thresholdPercentageT304 if included in the successHO- |
| | Config received before executing the last reconfiguration with sync; or |
| 1> | if the ratio between the value of the elapsed time of the timer T310 and |
| | the configured value of the timer T310, configured while the UE was |
| | connected to the source PCell before executing the last reconfiguration |
| | with sync or cell switch, is greater than thresholdPercentageT310 |
| | included in the successHO-Config if configured by the source PCell |
| | before executing the last reconfiguration with sync or cell switch; or |
| 1> | if the T312 associated to the measurement identity of the target cell was |
| | running at the time of initiating the execution of the reconfiguration |
| | with sync procedure and if the ratio between the value of the elapsed |
| | time of the timer T312 and the configured value of the timer T312, |
| | configured while the UE was connected to the source PCell before |
| | executing the last reconfiguration with sync or cell switch, is greater |
| | than thresholdPercentageT312 included in the successHO-Config if |
| | configured by the source PCell before executing the last reconfiguration |
| | with sync or cell switch ; or |

| | |
|---|---|
| 1> | if sourceDAPS-FailureReporting is included in the successHO- |

Config before executing the last reconfiguration with sync and is
set to true and if the last executed handover was a DAPS
handover and if an RLF occurred at the source PCell during the
DAPS handover while T304 was running; or

| | |
|---|---|
| 1> | if the ratio between the value of the elapsed time of the timer |

```
  Tcellswitch and the configured value of the timer Tcellswitch, included in
  the last applied LTM candidate cell configuration or LTM reference
  configuration, is greater than thresholdPercentageTcellswitch if included in
  the successHO-Config received before executing the last cell switch
  command:
```

| | |
|---|---|
| 2> | store the successful handover information in VarSuccessHO-Report |

| and determine the content in VarSuccessHO-Report as follows: | |
|---|---|
| 3> | clear the information included in VarSuccessHO-Report, if any; |
| 3> | set the plmn-IdentityList to include the list of EPLMNs stored by |
| | the UE (i.e., includes the RPLMN) and also include the list of |
| | equivalent NPNs; |
| 3> | set the c-RNTI to the C-RNTI assigned by the target PCell of the |
| | handover or LTM; |
| 3> | for the source PCell in which the last RRCReconfiguration |

| message including reconfigurationWithSync was applied or from | |
|---|---|
| which cell switch command is received: | |
| 4> | set the sourceCellID in sourceCellInfo to the global cell |
| | identity and tracking area code, if available, of the source |
| | PCell; |
| 4> | set the sourceCellMeas in sourceCellInfo to include the cell |
| | level RSRP, RSRQ and the available SINR, of the source PCell |
| | based on the available SSB and CSI-RS measurements |
| | collected up to the moment the UE sends |
| | RRCReconfigurationComplete message; |
| 4> | set the rsIndexResults in LTMsourceCellMeas to include all the |

available LTM SSB and LTM CSI-RS measurement quantities
of the source PCell collected up to the moment the UE sends
RRCReconfigurationComplete message; (This information may
be send in another variable under the same condition)

| | |
|---|---|
| 4> | set the LTMsourceCellMeas in LTMsourceCellInfo to |

| | include the cell level RSRP, RSRQ and the available SINR, of |
|---|---|
| | the source PCell based on the available LTM SSB and LTM |
| | CSI-RS measurements collected up to the moment the UE |
| | sends RRCReconfigurationComplete message; |
| 4> | set the rsIndexResults in sourceCellMeas to include all the |
| | available SSB and CSI-RS measurement quantities of the |
| | source PCell collected up to the moment the UE sends |
| | RRCReconfigurationComplete message; |
| 4> | set the rsIndexResults in sourceCellMeas to include all the |
| | available SSB and CSI-RS measurement quantities of the |
| | source PCell collected up to the moment the UE sends |
| | RRCReconfigurationComplete message; |
| 4> | if the last executed handover was a DAPS handover and if an |

| RLF occurred at the source PCell during the DAPS handover | |
|---|---|
| while T304 was running: | |
| 5> | set the rlf-InSourceDAPS in sourceCellInfo to true; |

| | |
|---|---|
| 3> | for the source PCell from which cell switch |

| command is received: | |
|---|---|
| 4> | set the sourceCellID in LTMsourceCellInfo to the global cell |
| | identity and tracking area code, if available, of the source |
| | PCell; |
| 4> | set the sourceCellMeas in LTMsourceCellInfo to include the |
| | cell level RSRP, RSRQ and the available SINR, of the source |
| | PCell based on the available SSB and CSI-RS measurements |
| | collected up to the moment the UE sends |
| | RRCReconfigurationComplete message; |
| 4> | set the rsIndexResults in LTMsourceCellMeas to include all the |

available LTM SSB and LTM CSI-RS measurement quantities
of the source PCell collected up to the moment the UE sends
RRCReconfigurationComplete message;

| | |
|---|---|
| 4> | set the LTMsourceCellMeas in LTMsourceCellInfo to |

| | include the cell level RSRP, RSRQ and the available SINR, of |
|---|---|
| | the source PCell based on the available LTM SSB and LTM |
| | CSI-RS measurements collected up to the moment the UE |
| | sends RRCReconfigurationComplete message; |
| 4> | set the rsIndexResults in LTMsourceCellMeas to include all the |

available SSB and CSI-RS measurement quantities of the
source PCell collected up to the moment the UE sends
RRCReconfigurationComplete message;

| | |
|---|---|
| 3> | for the target PCell indicated in the last applied |

| RRCReconfiguration message including reconfigurationWithSync | |
|---|---|
| or the last received cell switch command: | |
| 4> | set the targetCellID in targetCellInfo to the global cell identity |
| | and tracking area code, if available, of the target PCell; |
| 4> | set the targetCellMeas in targetCellInfo to include the cell level |
| | RSRP, RSRQ and the available SINR, of the target PCell based |
| | on the available SSB and CSI-RS measurements collected up |
| | to the moment the UE sends RRCReconfigurationComplete |
| | message; |
| 4> | set the rsIndexResults in targetCellMeas to include all the |

available SSB and CSI-RS measurement quantities of the target
PCell collected up to the moment the UE sends
RRCReconfigurationComplete message;

| | |
|---|---|
| 3> | for the target PCell indicated in the last received cell switch |

| command: | |
|---|---|
| 4> | set the targetCellID in LTMtargetCellInfo to the global cell |

identity and tracking area code, if available, of the target PCell;

| | |
|---|---|
| 4> | set the LTMtargetCellMeas in LTMtargetCellInfo to |

| | include the cell level RSRP, RSRQ and the available SINR, of |
|---|---|
| | the target PCell based on the available SSB and CSI-RS |
| | measurements collected up to the moment the UE sends |
| | RRCReconfigurationComplete message; |
| 4> | set the rsIndexResults in LTMtargetCellMeas to include all the |
| | available SSB and CSI-RS measurement quantities of the target |
| | PCell collected up to the moment the UE sends |
| | RRCReconfigurationComplete message; |
| 4> | if the last applied RRCReconfiguration message including |

| reconfigurationWithSync was included in the stored conditional | |
|---|---|
| cell switch command: | |
| 5> | set the timeSinceCHO-Reconfig to the time elapsed between |

the initiation of the execution of conditional reconfiguration
for the target PCell and the reception of the last
conditionalReconfiguration including the condRRCReconfig
of the target PCell in the source PCell;

| | |
|---|---|
| 3> | if the ratio between the value of the elapsed time of the timer |

| T304 and the configured value of the T304 timer, included in the | |
|---|---|
| last applied RRCReconfiguration message including the | |
| reconfigurationWithSync or the last received cell switch | |
| command, is greater than thresholdPercentageT304 if included in | |
| the successHO-Config received before executing the last | |
| reconfiguration with sync: | |
| 4> | set 1304-cause in shr-Cause to true; |
| 4> | set the ra-InformationCommon to include the random-access |

related information associated to the random access procedure
in the target PCell, as specified in clause 5.7.10.5;

| | |
|---|---|
| 3> | if the ratio between the value of the elapsed time of the timer |

T310 and the configured value of the T310 timer, configured

while the UE was connected to the source PCell before executing

the last reconfiguration with sync or cell switch command, is

greater than thresholdPercentageT310 included in the successHO-
Config if configured by the source PCell before executing the last

reconfiguration with sync:

| | |
|---|---|
| 4> | set t310-cause in shr-Cause to true; |

| | |
|---|---|
| 3> | if the T312 associated to the measurement identity of the target |

| cell was running at the time of initiating the execution of the | |
|---|---|
| reconfiguration with sync procedure and if the ratio between the | |
| value of the elapsed time of the timer T312 and the configured | |
| value of the T312 timer, configured while the UE was connected | |
| to the source PCell before executing the last reconfiguration with | |
| sync or cell switch command, is greater than | |
| thresholdPercentageT312 included in the successHO-Config if | |
| configured by the source PCell before executing the last | |
| reconfiguration with sync: | |
| 4> | set t312-cause in shr-Cause to true; |

| | |
|---|---|
| 3> | if sourceDAPS-FailureReporting included in the successHO- |

| Config if configured by the source PCell before executing the last | |
|---|---|
| reconfiguration with sync is set to true, and if the last executed | |
| handover was a DAPS handover and if an RLF occurred at the | |
| source PCell during the DAPS handover while T304 was running: | |
| 4> | set sourceDAPS-Failure in shr-Cause to true; |

| | |
|---|---|
| 3> | for each of the measObjectNR, configured by the source PCell, in |

| which the last RRCReconfiguration message including | |
|---|---|
| reconfigurationWithSync was applied: | |
| 4> | if measurements are available for the measObjectNR: |

| | |
|---|---|
| 5> | if the SS/PBCH block-based measurement quantities are |

| available: | |
|---|---|
| 6> | set the measResultListNR in measResultNeighCells to |
| | include all the available measurement quantities of the |
| | best measured cells, other than the source PCell or target |
| | PCell, ordered such that the cell with highest SS/PBCH |
| | block RSRP is listed first if SS/PBCH block RSRP |
| | measurement results are available, otherwise the cell with |
| | highest SS/PBCH block RSRQ is listed first if SS/PBCH |
| | block RSRQ measurement results are available, |
| | otherwise the cell with highest SS/PBCH block SINR is |
| | listed first, based on the available SS/PBCH block based |
| | measurements collected up to the moment the UE sends |
| | the RRCReconfigurationComplete message; |
| 6> | for each neighbour cell included, include the optional |

fields that are available;

NOTE 1: For the neighboring cells set included in measResultListNR in

measResultNeighCells ordered based on the SS/PBCH block
measurement quantities, the UE includes also the CSI-RS based
measurement quantities, if available.

| | |
|---|---|
| 5> | if the CSI-RS measurement quantities are available: |

| 6> | set the measResultListNR in measResultNeighCells to |
|---|---|
| | include all the available measurement quantities of the |
| | best measured cells, other than the source PCell and |
| | target PCell, ordered such that the cell with highest CSI- |
| | RS RSRP is listed first if CSI-RS RSRP measurement |
| | results are available, otherwise the cell with highest CSI- |
| | RS RSRQ is listed first if CSI-RS RSRQ measurement |
| | results are available, otherwise the cell with highest CSI- |
| | RS SINR is listed first, based on the available CSI-RS |
| | based measurements collected up to the moment the UE |
| | sends the RRCReconfigurationComplete message; |
| 6> | for each neighbour cell included, include the optional |

fields that are available;

NOTE 2: For the neighboring cells set ordered based on the CSI-RS

| | measurement quantities, the UE includes measurements only for |
|---|---|
| | the cells not yet included in measResultListNR in |
| | measResultNeighCells to avoid overriding SS/PBCH block-based |
| | ordered measurements. |
| 3> | for each of the measObjectEUTRA, configured by the source |

| PCell in which the last RRCReconfiguration message including | |
|---|---|
| reconfigurationWithSync was applied: | |
| 4> | if measurements are available for the measObjectEUTRA: |

| 5> | set the measResultListEUTRA in measResultNeighCells to |
|---|---|
| | include the best measured cells ordered such that the cell |
| | with highest RSRP is listed first if RSRP measurement |
| | results are available, otherwise the cell with highest RSRQ |
| | is listed first, based on measurements collected up to the |
| | moment the UE sends the RRCReconfigurationComplete |
| | message; |
| 5> | for each neighbour cell included, include the optional fields |

that are available;

| | |
|---|---|
| 3> | for each of the neighbour cells included in measResultNeighCells: |

| | |
|---|---|
| 4> | if the cell was a candidate target cell included in the |

| condRRCReconfig within the conditionalReconfiguration | |
|---|---|
| configured by the source PCell, in which the last | |
| RRCReconfiguration message including | |
| reconfigurationWithSync was applied: | |
| 5> | set the choCandidate to true in measResultNR; |

| | |
|---|---|
| 3> | for each of the LTM measurement object (or in any IE which |

| configures the reference signals and frequencies for LTM), | |
|---|---|
| configured in the UE: | |
| 4> | if measurements are available for the LTM measurements |

| | |
|---|---|
| 5> | if the SS/PBCH block-based measurements are available: |

| 6> | set the measResultListNR in LTMmeasResultNeighCells |
|---|---|
| | to include all the available measurement quantities of the |
| | measured LTM candidate cell cells, other than the source |
| | PCell in LTM or target PCell in LTM, ordered such that |
| | the cell with highest SS/PBCH block RSRP is listed first |
| | if SS/PBCH block RSRP measurement results are |
| | available, otherwise the cell with highest SS/PBCH block |
| | RSRQ is listed first if SS/PBCH block RSRQ |
| | measurement results are available, otherwise the cell with |
| | highest SS/PBCH block SINR is listed first, based on the |
| | available SS/PBCH block based measurements collected |
| | up to the moment the UE sends the RRC Reconfiguration |
| | Complete; |
| 6> | for each neighbour cell included, include the optional |

fields that are available;

NOTE 1: For the neighboring cells set included in measResultListNR in

LTMmeasResultNeighCells ordered based on the SS/PBCH block
measurement quantities, the UE includes also the CSI-RS based
measurement quantities, if available.

| | |
|---|---|
| 5> | if the CSI-RS measurement quantities are available: |

| 6> | set the measResultListNR in LTMmeasResultNeighCells |
|---|---|
| | to include all the available measurement quantities of the |
| | LTM candidate cell, other than the source LTM PCell and |
| | target LTM PCell, ordered such that the cell with highest |
| | CSI-RS RSRP is listed first if CSI-RS RSRP |
| | measurement results are available, otherwise the cell with |
| | highest CSI-RS RSRQ is listed first if CSI-RS RSRQ |
| | measurement results are available, otherwise the cell with |
| | highest CSI-RS SINR is listed first, based on the |
| | available CSI-RS based measurements collected up to the |
| | moment the UE sends the RRCReconfigurationComplete |
| | message; |
| 6> | for each neighbour cell included, include the optional |

fields that are available;

NOTE 2: For the neighboring cells set ordered based on the CSI-RS

| | measurement quantities, the UE includes measurements only for |
|---|---|
| | the cells not yet included in measResultListNR in |
| | LTMmeasResultNeighCells to avoid overriding SS/PBCH block- |
| | based ordered measurements. |
| 3> | for each of the neighbour cells included in measResultNeighCells |

| and LTM measResultNeighCells | |
|---|---|
| 4> | if the cell was a candidate LTM cell |

| | |
|---|---|
| 5> | set the LTMCandidate to true in measResultNR; |

| | |
|---|---|
| 3> | if available, set the locationInfo as in 5.3.3.7; |

| | |
|---|---|
| 1> | release successHO-Config configured by the source PCell and |
| | thresholdPercentageT304 if configured by the target PCell. |

The UE may discard the successful handover information, i.e., release the UE
variable VarSuccessHO-Report, 48 hours after the last successful handover
information is added to the VarSuccessHO-Report.

| | |
|---|---|
| SuccessHO-Report-r17 ::= | SEQUENCE { |
| sourceCellInfo-r17 | SEQUENCE { |
| sourcePCellId-r17 | CGI-Info-Logging-r16, |
| sourceCellMeas-r17 | MeasResultSuccessHONR-r17 |

OPTIONAL,

| | |
|---|---|
| rlf-InSourceDAPS-r17 | ENUMERATED {true} |

OPTIONAL
},

| | |
|---|---|
| targetCellInfo-r17 | SEQUENCE { |
| targetPCellId-r17 | CGI-Info-Logging-r16, |
| targetCellMeas-r17 | MeasResultSuccessHONR-r17 |

OPTIONAL
},

| | |
|---|---|
| measResultNeighCells-r17 | SEQUENCE { |
| measResultListNR-r17 | MeasResultList2NR-r16 |

OPTIONAL,

| | |
|---|---|
| measResultListEUTRA-r17 | MeasResultList2EUTRA-r16 |

OPTIONAL

| | |
|---|---|
| } | OPTIONAL, |
| locationInfo-r17 | LocationInfo-r16 |

OPTIONAL,

| | |
|---|---|
| timeSinceCHO-Reconfig-r17 | TimeSinceCHO-Reconfig-r17 |

OPTIONAL,

| | |
|---|---|
| shr-Cause-r17 | SHR-Cause-r17 |

OPTIONAL,

| | |
|---|---|
| ra-InformationCommon-r17 | RA-InformationCommon-r16 |

OPTIONAL,

| | |
|---|---|
| upInterruptionTimeAtHO-r17 | UPInterruptionTimeAtHO-r17 |

OPTIONAL,

| | |
|---|---|
| c-RNTI-r17 | RNTI-Value |

OPTIONAL,

| | |
|---|---|
| LTMsourceCellInfo-r17 | SEQUENCE { |
| sourcePCellId-r17 | CGI-Info-Logging-r16, |
| LTMsourceCellMeas-r17 | LTMMeasResultSuccessHONR- |
| r18 | OPTIONAL, |
| rlf-InSourceDAPS-r17 | ENUMERATED {true} |

OPTIONAL
},

| | |
|---|---|
| LTMtargetCellInfo-r17 | SEQUENCE { |
| targetPCellId-r17 | CGI-Info-Logging-r16, |
| LTMtargetCellMeas-r17 | LTMMeasResultSuccessHONR- |
| r18 | OPTIONAL |

},

| | |
|---|---|
| LTMmeasResultNeighCells-r17 | SEQUENCE { |
| measResultListNR-r17 | LTMMeasResultList2NR-r18 |

OPTIONAL,

| | |
|---|---|
| } | OPTIONAL, |

...
}

In an embodiment, upon receiving cell switch command from the network apparatus, the UE (101) keeps the successful handover configuration configured for LTM and releases the successful handover configuration configured for LTM upon explicitly released by the network apparatus (such as gNB) or during a RRC Reestablishment or during RRC Release (for both the transition to RRC_IDLE and RRC_INACTIVE).

During T390 handling, upon executing cell switch (for e.g UE RRC executes cell switch upon receiving an indication from lower layers that cell switch command ins received or based on some condition for executing LTM is satisfied), the UE (101) stops the timer T390, if running (such as T390 as defined or described in TS 38.331) for all access categories. In a specific embodiment, this is applied only for cell switch command for MCG.

During, T304 handling the UE (101) stops T304 (such as T304 as defined in TS38.331) upon executing cell switch (for e.g UE RRC executes cell switch upon receiving an indication from lower layers that cell switch command is received or based on some condition for executing LTM is satisfied).

In an embodiment, the UE (101) updates the RLF report when LTM measurements are configured.

In an embodiment, the UE (101) which is configured with LTM measurements or LTM candidate cells and has experienced radio link failure or handover failure or LTM failure includes the latest LTM measurements in the Radio Link Failure report (for e.g. RLF-Report or Handover failure report as in NR R17 specification) for LTM. In an embodiment, the latest measurements is the last measurements taken. In an embodiment, the latest measurements is the last measurements reported. In an embodiment, the UE (101) includes the average of LTM measurements over a specific period of time to the network in the RLF report. In an embodiment, LTM measurements can be one of the periodic measurements, aperiodic measurements, semi periodic measurements or event based measurements performed by UE as configured by gNB for LTM.

In an embodiment, the LTM measurements included in RLF report are RSRP (Reference Signal Received Power) measurements. In an embodiment, the LTM measurements included in RLF report are SINR (Signal to Interference and Noise Ratio) measurements. In an embodiment, the LTM measurements included in RLF report are RSRQ (Reference Signal Received Quality) measurements.

The UE (101) configured with both LTM and L3 measurements for the same cell includes only L3 measurements in the RLF report in above case. In an alternate embodiment, the UE (101) configured with both LTM and L3 measurements for the same cell includes both LTM and L3 measurements in the RLF report in above case. In an alternate embodiment, the UE (101) configured with both LTM and L3 measurements for the same cell includes LTM measurements in the RLF report in above case.

In an embodiment, upon a LTM execution failure (for e.g. Tcellswitch expiry), the UE (101) includes the RLF cause (such as rlf-Cause-r16 in NR TS 38.331) as a cause value which informs the network is due to LTM failure (such as Tcellswitch expiry or LTM execution failure). In an embodiment, upon a LTM execution failure (for e.g. Tcellswitch expiry), UE (101) informs the network apparatus that the last handover type is LTM (such as lastHO-Type-r17 is set to an enumerated value which informs the last handover type is LTM) in the RLF report.

In an embodiment, the UE (101) reports the SHR for LTM in RRC messages such as UE Information Response. In an embodiment, Gnb CU receives the RRC message including SHR for LTM and uses the same for optimizing LTM configuration. In an embodiment, Gnb CU sends the receiving SHR for LTM to gNB DU in F1AP messages such as Access and Mobility Indication.

FIG. 2 is a block diagram that illustrates a network apparatus for optimizing LTM in a telecommunication network system, according to the embodiment as disclosed herein.

The network apparatus (201) includes a processor (203), a memory (207), an I/O interface (205) and a LTM controller (109). The network apparatus (201) communicates with the UE (101) for self-optimization during the handover. For example, the network apparatus (201) can include, but not limited to a base station access point, a central server, or similar equipment. Further, the processor (203) of the network apparatus (201) communicates with the memory (207), the I/O interface (205) and the LTM controller (209). The processor (203) is configured to execute instructions stored in the memory (207) and to perform various processes. The processor (203) can include one or a plurality of processors, can be a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

Further, the memory (207) of the network apparatus (201) includes storage locations to be addressable through the processor (203). The memory (207) is not limited to a volatile memory and/or a non-volatile memory. Further, the memory (207) can include one or more computer-readable storage media. The memory (207) can include non-volatile storage elements. For example, non-volatile storage elements can include magnetic hard discs, optical discs, floppy discs, flash memories, or forms of electrically programmable memories (EPROM) or electrically erasable and programmable (EEPROM) memories. The memory (207) can store the media streams such as audios stream, video streams, haptic feedbacks and the like. Also, the memory (207) of the network apparatus (201) can store several information received from the UE (101). For example, the memory (207) can store several information such as SHR received from the UE (101). The SHR comprises at least one of LTM measurements, cause of SHR, source cell-id, and target cell-id.

The I/O interface (205) transmits the information between the memory (207) and external peripheral devices. The peripheral devices are the input-output devices associated with the network apparatus (201). The I/O interface (205) receives several information from the UE (101). The several information received from the UE (101) can include but not limited to SHR including at least one of LTM measurements, cause of SHR, source cell-id, and target cell-id.

The LTM controller (209) communicates with the I/O interface (205) and memory (207) for optimizing LTM in a telecommunication network system. The LTM controller (209) is an innovative hardware that is realized through the physical implementation of both analog and digital circuits, including logic gates, integrated circuits, microprocessors, microcontrollers, memory circuits, passive and active electronic components, as well as optical components. The LTM controller (209) of the network apparatus (201) transmits a SHR configuration of at least one of a source cell and a target cell in a signalling message for reporting successful handover. Further, the LTM controller (209) receives a SHR upon successful handover of the UE (101) from the source cell to the target cell. Further, the LTM controller (209) transmits the SHR to at least one of DU OAM for optimization of network resources.

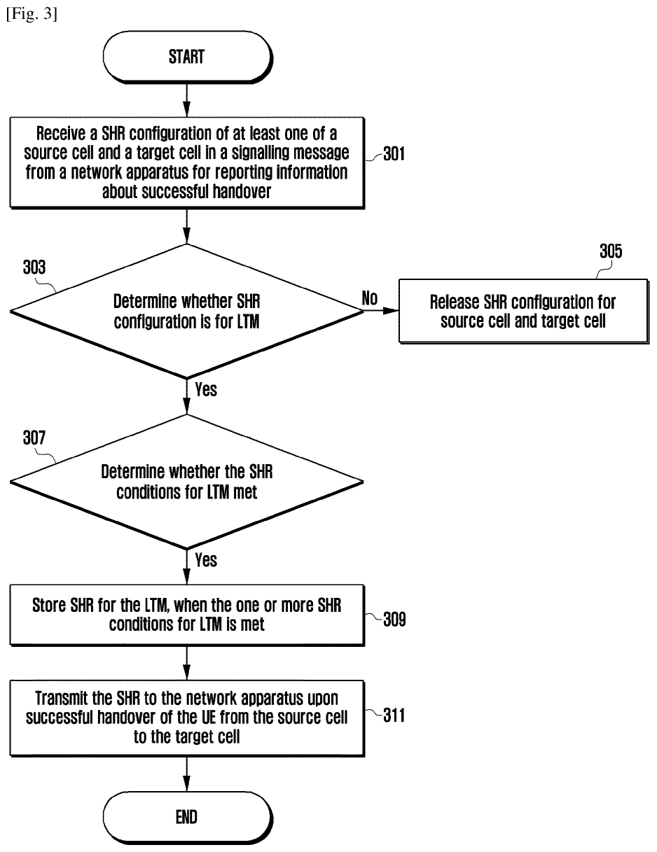

FIG. 3 is a flow diagram that illustrates a method for optimizing LTM by UE in a telecommunication network system, according to the embodiment as disclosed herein.

At block 301, the UE (101) receives the SHR configuration of at least one of a source cell and a target cell in a signalling message from the network apparatus (201) for reporting successful handover. The SHR configuration includes but not limited to the first threshold percentage for the first timer, the second threshold percentage for the second timer from the source cell. The SHR configuration also includes the third threshold percentage for the third timer from the target cell of the network apparatus (201).

At block 303, the UE (101) determines whether the SHR configuration is for LTM or Layer 3 (L3) mobility.

At block 305, the UE (101) releases the SHR configuration for the source cell and the target cell, when the SHR configuration is not for LTM and the cell switch is for Master cell group.

At block 307, the UE (101) determines whether the one or more SHR conditions for included in the SHR configuration for the LTM is met. Particularly, the UE (101) determined whether ratio between elapsed time of the first timer and the first timer value greater than the first threshold percentage. Also, the UE (101) determines whether ratio between elapsed time of the second timer at the UE and the second timer value is greater than the second threshold percentage. Further, the UE (101) determines whether ratio between elapsed time of the third timer at the UE and the third timer value is greater than the third threshold percentage.

At block 309, the UE (101) stores the SHR for the LTM, when any one of the SHR conditions is satisfied. Particularly, the UE (101) stores the SHR when ratio between elapsed time of the first timer and the first timer value greater than the first threshold percentage. Also, the UE (101) stores the SHR when ratio between elapsed time of the second timer at the UE and the second timer value is greater than the second threshold percentage. Also, the UE (101) stores the SHR when the ratio between elapsed time of the third timer at the UE and the third timer value is greater than the third threshold percentage.

At block 311, the UE (101) transmits the SHR to the network apparatus (201) upon the successful handover of the UE (101) from the source cell to the target cell.

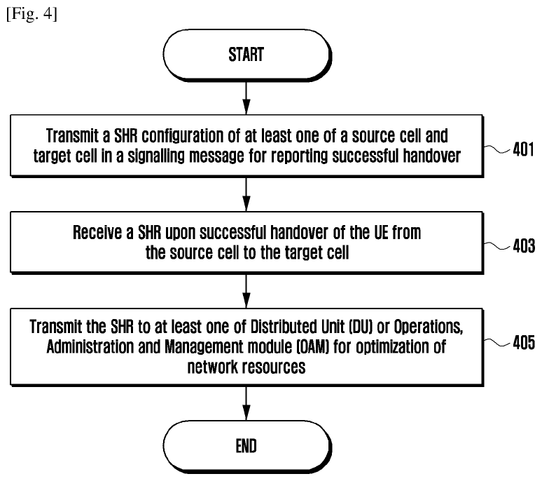

FIG. 4 is a flow diagram that illustrates a method for optimizing LTM by network apparatus in a telecommunication network system, according to the embodiment as disclosed herein.

At block 401, the network apparatus (201) transmits the SHR configuration to the UE (101). The network apparatus includes multiple network cells, where one of the cell in which the UE (101) is currently serving is referred to as a source cell. Further, during the handover, the UE (101) moves towards the target cell. Hence, the network apparatus transmits the SHR configuration of the source cell and the target cell to the UE (101). The SHR configuration is transmitted to the UE (101) for reporting after the successful handover from the source cell to the target cell.

At block 403, the network apparatus (201) receives the SHR from the UE (101) upon the successful handover of the UE (101) from the source cell to the target cell.

At block 405, the network apparatus (201) transmits the SHR to the DU or OAM for the optimization of the network resources and parameters such as T304 timer value, random access resources, the measurement threshold at which LTM will be triggered, the measurement threshold at which LTM early synchronization is triggered, whether to configure UE based TA measurements etc.

The various actions, acts, blocks, steps, or the like in the method is performed in the order presented, in a different order or simultaneously. Further, in some embodiments, some of the actions, acts, blocks, steps, or the like are omitted, added, modified, skipped, or the like without departing from the scope of the proposed method.

The foregoing description of the specific embodiments will so fully reveal the general nature of the embodiments herein that others can, by applying current knowledge, readily modify and or adapt for various applications such specific embodiments without departing from the generic concept, and, therefore, such adaptations and modifications are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

List of Reference Numerals

| Reference Numerals | Description |
|---|---|
| 101 | User Equipment |
| 103 | Processor |
| 105 | I/O interface |
| 107 | Memory |
| 109 | LTM controller |
| 201 | Network Apparatus |
| 203 | Processor |
| 205 | I/O interface |
| 207 | Memory |
| 209 | LTM controller |

1. A method performed by a terminal in a wireless communication system, the method comprising:
receiving, from a base station, a message comprising configuration information on a successful handover; and
in case that the terminal performs a layer 1/layer 2 (L1/L2) triggered mobility (LTM) cell switch, releasing the configuration information on the successful handover,
wherein the LTM cell switch is triggered by the base station.

2. The method of claim 1, further comprising:
in case that the terminal performs the LTM cell switch, releasing information on a threshold for a ratio in percentage associated with a timer.

3. The method of claim 1, further comprising:
in case that the LTM cell switch is successful or has failed, releasing the configuration information on the successful handover.

4. The method of claim 1,
wherein the information on the successful handover is for an LTM.

5. A method performed by a base station in a wireless communication system, the method comprising:
transmitting, to a terminal, a message comprising configuration information on a successful handover,
wherein, in case that the terminal performs a layer 1/layer 2 (L1/L2) triggered mobility (LTM) cell switch, the configuration information on the successful handover is released,
wherein the LTM cell switch is triggered by the base station.

6. The method of claim 5,
wherein, in case that the terminal performs the LTM cell switch, information on a threshold for a ratio in percentage associated with a timer is released.

7. The method of claim 5,
wherein, in case that the LTM cell switch is successful or has failed, the configuration information on the successful handover is released,
wherein the information on the successful handover is for an LTM.

8. A terminal in a wireless communication system, the terminal comprising:
a transceiver; and
at least one processor coupled with the transceiver and configured to:
receive, from a base station, a message comprising configuration information on a successful handover, and
in case that the terminal performs a layer 1/layer 2 (L1/L2) triggered mobility (LTM) cell switch, release the configuration information on the successful handover,
wherein the LTM cell switch is triggered by the base station.

9. The terminal of claim 8, wherein the at least one processor is further configured to:
in case that the terminal performs the LTM cell switch, release information on a threshold for a ratio in percentage associated with a timer.

10. The terminal of claim 8, wherein the at least one processor is configured to:
in case that the LTM cell switch is successful or has failed, release the configuration information on the successful handover.

11. The terminal of claim 8,
wherein the information on the successful handover is for an LTM.

12. A base station in a wireless communication system, the base station comprising:
a transceiver; and
at least one processor coupled with the transceiver and configured to:
transmit, to a terminal, a message comprising configuration information on a successful handover,
wherein, in case that the terminal performs a layer 1/layer 2 (L1/L2) triggered mobility (LTM) cell switch, the configuration information on the successful handover is released,
wherein the LTM cell switch is triggered by the base station.

13. The base station of claim 12,
wherein, in case that the terminal performs the LTM cell switch, information on a threshold for a ratio in percentage associated with a timer is released.

14. The base station of claim 12,
wherein, in case that the LTM cell switch is successful or has failed, the configuration information on the successful handover is released.

15. The base station of claim 12,
wherein the information on the successful handover is for an LTM.
